(19) United States
(12) Patent Application Publication
(10) Pub. No.: US 2023/0363854 A1
(43) Pub. Date: Nov. 16, 2023

(54) CUSTOM TOOTH CLAMP

(71) Applicant: Cyberdontics (USA), Inc., San Francisco, CA (US)

(72) Inventors: Christopher CIRIELLO, San Francisco, CA (US); James JACKSON, Victoria (CA); Gene WEY, Victoria (CA); Nathan John MULLER, Victoria (CA)

(21) Appl. No.: 18/066,892

(22) Filed: Dec. 15, 2022

Related U.S. Application Data
(63) Continuation of application No. PCT/US2021/037635, filed on Jun. 16, 2021.
(60) Provisional application No. 63/040,401, filed on Jun. 17, 2020.

(51) Int. Cl. A61C 5/82

(52) U.S. Cl. CPC A61C 5/82

(57) ABSTRACT

Provided herein are tooth clamping systems, methods, and kits for performing a dental procedure with a dental cutting machine guided by three-dimensional data associated with an impression of one or more teeth of a patient.

### CROSS-REFERENCE

This application is a continuation of International Application No. PCT/US2021/037635, filed Jun. 16, 2021, which claims the benefit of U.S. Provisional Application No. 63/040,401, filed Jun. 17, 2020, each which are hereby incorporated by reference in their entirety herein.

### BACKGROUND

Dental procedures are performed daily to cure a variety of oral conditions. The ability to perform dental procedures with high accuracy improves the effectiveness of such procedures and reduces patient side effects.

### SUMMARY

One aspect provided herein is a tooth clamping system for performing a dental procedure, the system comprising: a first chassis: and a second chassis rotatably coupled to the first chassis; wherein the first chassis and the second chassis form a cavity when the system is in a closed state; wherein a proximal portion of the first chassis and a proximal portion of the second chassis form a gantry when the system is in the closed state; and wherein a surface of first chassis, the second chassis, or both, comprise a fiducial.

In some embodiments, the first chassis and the second chassis are rotatably coupled at a distal end of the first chassis or the second chassis. In some embodiments, the first chassis and the second chassis are rotatably coupled at a distal end of the first chassis and the second chassis. In some embodiments, the cavity has a cross-section shape comprising a circle, a square, a rectangle, an ellipsoid, an obround, or any combination thereof. In some embodiments, the cavity has an arcuate cross-sectional shape. In some embodiments, the cavity has arcuate and obround cross-sectional shape. In some embodiments, an inner surface of the cavity is rounded. In some embodiments, the fiducial is located between the gantry and the cavity on the first chassis, the second chassis, or both. In some embodiments, the fiducial is located on a mesial area the gantry on of the first chassis, the second chassis, or both. In some embodiments, the second chassis is rotatably coupled to the first chassis by a hinge, a pin, a hole, a tie, a band, a magnet, a clasp, a hook, a screw, a nut, a washer, or any combination thereof. In some embodiments, the cavity is configured to receive an impression media. In some embodiments, an interior surface of the cavity comprises a pin to receive the impression media. In some embodiments, the impression media comprises a primary impression media portion and a secondary impression media portion. In some embodiments, the first chassis receives at least a portion of the primary impression media portion, the secondary impression media portion, or both. In some embodiments, the second chassis receives at least a portion of the primary impression media portion, the secondary impression media portion, or both. In some embodiments, the cavity is configured to receive one or more patient teeth. In some embodiments, the impression media is configured to form a direct impression of the one or more patient teeth. In some embodiments, the impression material is polymer. In some embodiments, the proximal portion of the first chassis contacts at least a portion of the proximal portion of the second chassis when the system is in the closed state. In some embodiments, the gantry is configured to couple to a dental cutting machine. In some embodiments, the dental cutting machine is an automated dental cutting machine.

Another aspect provided herein is a tooth clamping system for performing a dental procedure, the system comprising: a first chassis: a second chassis rotatably coupled to the first chassis; and wherein a proximal portion of the first chassis and a proximal portion of the second chassis form a gantry when the system is in the closed state; and wherein a surface of first chassis, the second chassis, or both, comprise a fiducial an impression media portion in the cavity.

In some embodiments, the first chassis and the second chassis are rotatably coupled at a distal end of the first chassis or the second chassis. In some embodiments, the first chassis and the second chassis are rotatably coupled at a distal end of the first chassis and the second chassis. In some embodiments, the cavity has a cross-section shape comprising a circle, a square, a rectangle, an ellipsoid, an obround, or any combination thereof. In some embodiments, the cavity has an arcuate cross-sectional shape. In some embodiments, the cavity has arcuate and obround cross-sectional shape. In some embodiments, an inner surface of the cavity is rounded. In some embodiments, the fiducial is located between the gantry and the cavity on the first chassis, the second chassis, or both. In some embodiments, the fiducial is located on a mesial area the gantry on of the first chassis, the second chassis, or both. In some embodiments, the second chassis is rotatably coupled to the first chassis by a hinge, a pin, a hole, a tie, a band, a magnet, a clasp, a hook, a screw, a nut, a washer, or any combination thereof. In some embodiments, the impression media comprises a primary impression media portion and a secondary impression media portion. In some embodiments, a surface of the first chassis, a surface of the second chassis, or both, that define the cavity, comprise a pin to receive primary impression media portion, the secondary impression media portion or both. In some embodiments, the first chassis receives at least a portion of the primary impression media portion, the secondary impression media portion, or both. In some embodiments, the second chassis receives at least a portion of the primary impression media portion, the secondary impression media portion, or both. In some embodiments, the cavity is configured to receive one or more patient teeth. In some embodiments, the impression media is configured to form a direct impression of the one or more patient teeth. In some embodiments, the proximal portion of the first chassis contacts at least a portion of the proximal portion of the second chassis when the system is in the closed state. In some embodiments, the gantry is configured to couple to a dental cutting machine. In some embodiments, the dental cutting machine is an automated dental cutting machine.

Another aspect provided herein is a method for performing a dental procedure, the method comprising: providing the tooth clamping system herein; performing a dental arch anatomy scan of a patient; inserting the primary impression media portion and the secondary impression media portion into the cavity; installing the system into the mouth of the patient by clamping two or more teeth of the patient between at least a portion of the primary impression media portion and the secondary impression media portion until the system is in the closed state; removing the system from the mouth of the patient once the primary impression media portion and the secondary impression media portion have hardened; performing an impression scan of the fiducial and one or more surfaces of the primary impression media portion and the secondary impression media portion; overlaying the dental arch anatomy scan and the impression scan to form an overlaid model; determining a cut path based on the overlaid model; reinstalling the system into the mouth of the patient; coupling the gantry to a dental cutting machine; and cutting at least a portion of one or more of the two or more teeth of the patient, based on the cut path.

In some embodiments, performing the impression scan comprises forming a three dimensional relationship between the fiducial and the one or more surfaces of the primary impression media portion and the secondary impression media portion. In some embodiments, the dental cutting machine is an automated dental cutting machine. In some embodiments, the impression scan comprises a geometric relationship between the fiducial and the one or more surfaces of the primary impression media.

Another aspect provided herein is a kit for performing a dental procedure, the kit comprising: the tooth clamping system provided herein; and a packaging for the primary impression media portion, the secondary impression media portion, or both. In some embodiments, the packaging prevents the primary impression media portion, the secondary impression media portion, or both from hardening during storage and/or transit. In some embodiments, the kit further comprises an instruction manual.

Another aspect provided herein is a tooth clamp for performing a dental procedure on a subject, the tooth clamp comprising: a first arch segment, wherein at least a portion of the first arch segment comprises a negative imprint corresponding with at least a portion of a first row of teeth of the subject, and wherein the first arch segment has a procedure access opening therethrough; a second arch segment engaging at least a portion of a second row of teeth of the subject opposite the first row of teeth, the second arch segment comprising an arcuate channel; a cheek retracting surface coupled to at least a portion of the first arch segment, at least a portion of the second arch segment, or both; and a coupling mechanism extending from at least a portion of the first arch segment, at least a portion of the second arch segment, or both, wherein the coupling mechanism couples to a dental cutting machine.

In some embodiments, the first arch segment is an maxillary arch segment and wherein the second arch segment is a mandibular arch segment. In some embodiments, the first arch segment is a mandibular arch segment and wherein the second arch segment is an maxillary arch segment. In some embodiments, the negative imprint of the tooth of the subject is determined based on a dental arch anatomy scan. In some embodiments, a wall of the procedure access opening is shaped based on negative imprint of a treatment tooth of the subject. In some embodiments, the procedure access opening comprises a primary procedure access opening proximal to tooth of the subject and a secondary procedure access opening proximal to tooth of the subject, wherein a wall of the primary procedure access opening is shaped based on negative imprint of a treatment tooth of the subject, and wherein the secondary procedure access opening has a width, length, or both greater than a width, length, or both of the primary procedure access. In some embodiments, at least a portion of the first arch segment is removable from another portion of the first arch segment. In some embodiments, the coupling mechanism further comprises a fiducial. In some embodiments, the coupling mechanism is a rigid coupling mechanism. In some embodiments, the coupling mechanism comprises a pin, a threaded feature, a clip, a magnet, a nut, a bolt, a catch, a clasp, or any combination thereof. In some embodiments, the tooth clamp is formed by 3D printing, injection molding, or both. In some embodiments, the tooth clamp further comprises a tongue blocking portion extending from at least a portion of the first arch segment, at least a portion of the second arch segment, or both. In some embodiments, the tooth clamp further comprises a gasket coupled to at least a portion of the first arch segment configured to suction the tooth clamp to the tooth of the subject.

Another aspect provided herein is a tooth clamp system for performing a dental procedure on a subject, the tooth clamp system comprising the tooth clamp provided herein, and a gum support coupled to at least a portion of the first arch segment of the tooth clamp, at least a portion of the second arch segment of the tooth clamp, or both.

Another aspect provided herein is a tooth clamp system for performing a dental procedure on a subject, the tooth clamp system comprising: a clamp insert having one or more interior surfaces, wherein at least a portion of the one or more interior surfaces is shaped with a negative imprint of a tooth of the subject; a clamp frame comprising: a clamp insert coupling receiving the clamp insert; a cheek retracting surface; a second arch segment comprising an arcuate channel; and a coupling mechanism that removably couples the clamp frame to a dental cutting machine.

In some embodiments, the second arch segment is a mandibular arch segment. In some embodiments, the second arch segment is an maxillary arch segment. In some embodiments, the negative imprint of the tooth of the subject is determined based on a dental arch anatomy scan. In some embodiments, the coupling mechanism further comprises a fiducial. In some embodiments, the coupling mechanism is a rigid coupling mechanism. In some embodiments, the coupling mechanism comprises a pin, a threaded feature, a clip, a magnet, a nut, a bolt, a catch, a clasp, or any combination thereof. In some embodiments, the clamp insert, the clamp frame, or both are formed by 3D printing, injection molding, or both. In some embodiments, the tooth clamp system further comprises In some embodiments, the clamp frame further comprises a tongue blocking portion extending from at least a portion of the first arch segment, at least a portion of the second arch segment, or both. In some embodiments, the clamp insert comprises a compressible portion. In some embodiments, the tooth clamp system further comprises a tightening mechanism compressing the compressible portion to clamp the tooth clamp system to the tooth of a subject. In some embodiments, the tightening mechanism comprises a cam, a slide, a wedge, a gear, a pulley, a worm drive, a bar linkage, a ratchet, a spring, a lever a spring, or any combination thereof. In some embodiments, the tooth clamp system further comprises a gum support removably coupled to the clamp frame.

Another aspect provided herein is a tooth clamp system for performing a dental procedure on a subject, the tooth clamp system comprising: a clamp frame comprising: a first arch segment comprising a procedure access cavity therethrough; a coupling mechanism extending from at least a portion of the first arch segment, wherein the coupling mechanism couples to a dental cutting machine; and a first spring clip fastener; and a spring clip configured to removably couple to the clamp frame, the spring clip comprising: a first clip segment, wherein at least a portion of the distal edge of the first clip segment has a concave shape; a second clip segment, wherein at least a portion distal edge of the second clip segment has a concave shape; and a third clip segment between the first clip segment and the second clip segment, wherein the third clip segment comprises a second spring clip fastener that removably couples to the first spring clip fastener.

In some embodiments, at least a portion of the first arch segment comprises a negative imprint of a tooth of the subject. In some embodiments, the first arch segment is an maxillary arch segment. In some embodiments, the first arch segment is a mandibular arch segment. In some embodiments, the coupling mechanism further comprises a fiducial. In some embodiments, the coupling mechanism is a rigid coupling mechanism. In some embodiments, the coupling mechanism comprises a pin, a threaded feature, a clip, a magnet, a nut, a bolt, a catch, a clasp, or any combination thereof. In some embodiments, the clamp frame is formed by 3D printing, injection molding, or both. In some embodiments, the clamp frame further comprises a tongue blocking portion extending from at least a portion of the first arch segment. In some embodiments, the clamp frame further comprises a gasket coupled to at least a portion of the arch overlay surface configured to suction the tooth clamp to the tooth of the subject. In some embodiments, the clamp system further comprises an impression material in the clamp frame.

Another aspect provided herein is a tooth clamp for performing a dental procedure on a subject, the tooth clamp comprising one or more segments, wherein at least a portion of the segment comprises a negative imprint corresponding with at least a portion of a one or more teeth. In some embodiments, one of the arch segments has a procedure access opening to access a region of the dental anatomy. In some embodiments, the tooth clamp further comprises a cheek retracting surface coupled to at least a portion of an arch segment. In some embodiments, the tooth clamp further comprises a coupling mechanism extends between multiple arch segments, either on the maxillary or mandibular arch of the mouth. In some embodiments, the tooth clamp is configured to removably couple to the spring clip comprising: a first clip segment, wherein at least a portion of the distal edge of the first clip segment has a concave shape; a second clip segment, wherein at least a portion distal edge of the second clip segment has a concave shape; and a third clip segment between the first clip segment and the second clip segment, wherein the third clip segment comprises a second spring clip fastener that removably couples to the first spring clip fastener.

In some embodiments, the teeth are in a row or opposing.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a top-view illustration of an exemplary primary tooth clamping system, per an embodiment herein;

FIG. 1B shows a side-view illustration of an exemplary primary tooth clamping system, per an embodiment herein;

FIG. 2A shows a top-view illustration of an exemplary chassis, per an embodiment herein;

FIG. 2B shows a side-view illustration of an exemplary chassis, per an embodiment herein;

FIG. 3A shows a top-view illustration of an exemplary impression media, per an embodiment herein;

FIG. 3B shows a side-view illustration of an exemplary impression media, per an embodiment herein;

FIG. 4 shows a top-view illustration of an exemplary primary tooth clamping system in an open state, per an embodiment herein;

FIG. 5 shows a top-view illustration of an exemplary primary tooth clamping system forming an impression in the impression media, per an embodiment herein;

FIG. 6 shows a top-view illustration of an exemplary primary tooth clamping system in an open state with an impression in the impression media, per an embodiment herein;

FIG. 7 shows a top-view illustration of an exemplary primary tooth clamping system in a closed state with an impression in the impression media, per an embodiment herein;

FIG. 8 shows an exemplary side-view illustration of performing an impression scan of the exemplary tooth clamping system, per an embodiment herein;

FIG. 9A shows a top-view illustration of an exemplary packaging for containing the impression media, per an embodiment herein;

FIG. 9B shows a top-view illustration of an exemplary impression media and a packaging for containing the impression media, per an embodiment herein;

FIG. 10 shows an image of an exemplary primary tooth clamping system, per an embodiment herein;

FIG. 11 shows an image of installing an exemplary primary tooth clamping system into the mouth of the patient by clamping two or more teeth of the patient, per an embodiment herein;

FIG. 12 shows an image of an exemplary primary tooth clamping system installed into the mouth of the patient, per an embodiment herein;

FIG. 13 shows an illustration of an exemplary primary tooth clamping system installed into the mouth of a patient, per an embodiment herein;

FIG. 14 shows an illustration of an exemplary primary tooth clamping system coupled to a dental cutting machine, per an embodiment herein;

FIG. 15A shows a front-right-top perspective illustration of an exemplary secondary tooth clamp, per an embodiment herein;

FIG. 15B shows a back-left-top perspective illustration of an exemplary secondary tooth clamp, per an embodiment herein;

FIG. 16A shows a front-right-top perspective illustration of an exemplary tertiary tooth clamp system, per an embodiment herein;

FIG. 16B shows a back-left-bottom perspective illustration of an exemplary tertiary tooth clamp system, per an embodiment herein;

FIG. 17 shows a front-right-top perspective section-view illustration of an exemplary tertiary tooth clamp system, per an embodiment herein;

FIG. 18 shows a top view illustration of an exemplary tertiary tooth clamp system, per an embodiment herein;

FIG. 19 shows a back-left-top perspective illustration of an exemplary quaternary tooth clamp system, per an embodiment herein;

FIG. 20A shows a front-left-top perspective illustration of an exemplary quaternary tooth clamp system, per an embodiment herein;

FIG. 20B shows a front-right-top perspective illustration of an exemplary spring clip, per an embodiment herein;

FIG. 21 shows a back-right-top perspective illustration of an exemplary tooth clamp system, having a gasket, per an embodiment herein;

FIG. 22A shows a cross-section illustration of an exemplary first gum support, per an embodiment herein;

FIG. 22B shows a perspective cross-section illustration of an exemplary second gum support, per an embodiment herein;

FIG. 22C shows a perspective cross-section illustration of an exemplary third gum support, per an embodiment herein;

FIG. 23 shows a cross-section illustration of an exemplary dental cutting machine, per an embodiment herein;

FIG. 24 shows a diagram an exemplary dental cutting machine, per an embodiment herein; and

FIG. 25 shows a non-limiting example of a computing device; in this case, a device with one or more processors, memory, storage, and a network interface.

### DETAILED DESCRIPTION

Provided herein are systems, methods, and kits, whose components, features, method steps, or any combination thereof herein enable dental treatments with high accuracy. Such high accuracy improves the effectiveness of such procedures and reduces patient side effects.

### Primary Tooth Clamping System

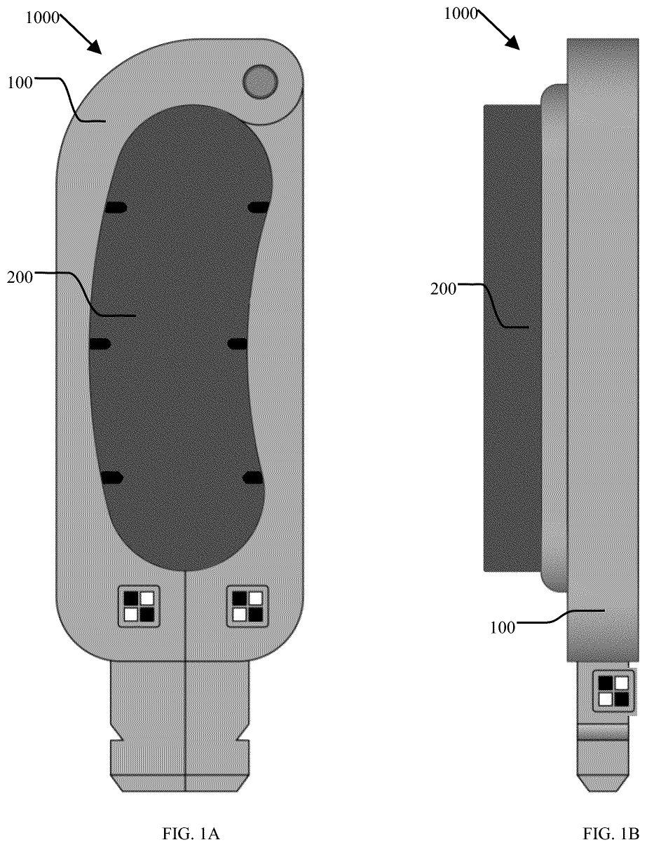

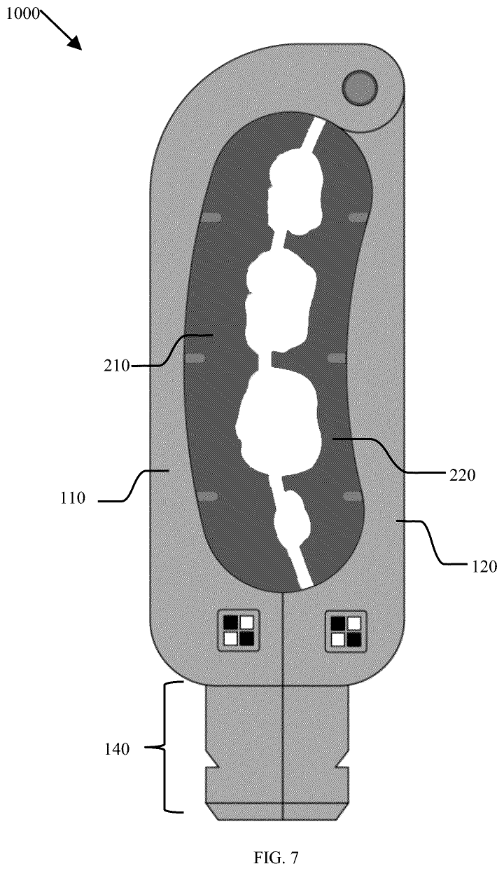

One aspect provided herein is a primary tooth clamping system 1000 for performing a dental procedure. Per FIGS. 1-7, in some embodiments, the system comprises a first chassis 110 and a second chassis 120.

In some embodiments, the first chassis 110 and the second chassis 120 are rotatably coupled. In some embodiments, the first chassis 110 and the second chassis 120 are rotatably coupled to enable the first chassis 110 and the second chassis 120 to clamp to a tooth 300 of a patient. In some embodiments, the first chassis 110 and the second chassis 120 are rotatably coupled at a distal end of the first chassis 110 or the second chassis 120. In some embodiments, the first chassis 110 and the second chassis 120 are rotatably coupled at a distal end of the first chassis 110 and the second chassis 120. In some embodiments, the first chassis 110 and the second chassis 120 are coupled such that the first chassis 110 rotates with respect to the second chassis 120 in an angular range of about 5 degrees to about 200 degrees. As shown, in some embodiments, the second chassis 120 is rotatably coupled to the first chassis 110 by a hinge 160. Alternatively, in some embodiments, the second chassis 120 is rotatably coupled to the first chassis 110 by a pin, a hole, a tie, a band, a magnet, a clasp, a hook, a screw, a nut, a washer, or any combination thereof. In some embodiments, the first chassis 110 and the second chassis 120 have mirrored symmetry. In some embodiments, the second chassis 120 is removably coupled to the first chassis 110. In some embodiments, the second chassis 120 is removably coupled to the first chassis 110 to enable cleaning and sterilization of the first chassis 110 and the second chassis 120. In some embodiments, the second chassis 120 is permanently coupled to the first chassis 110.

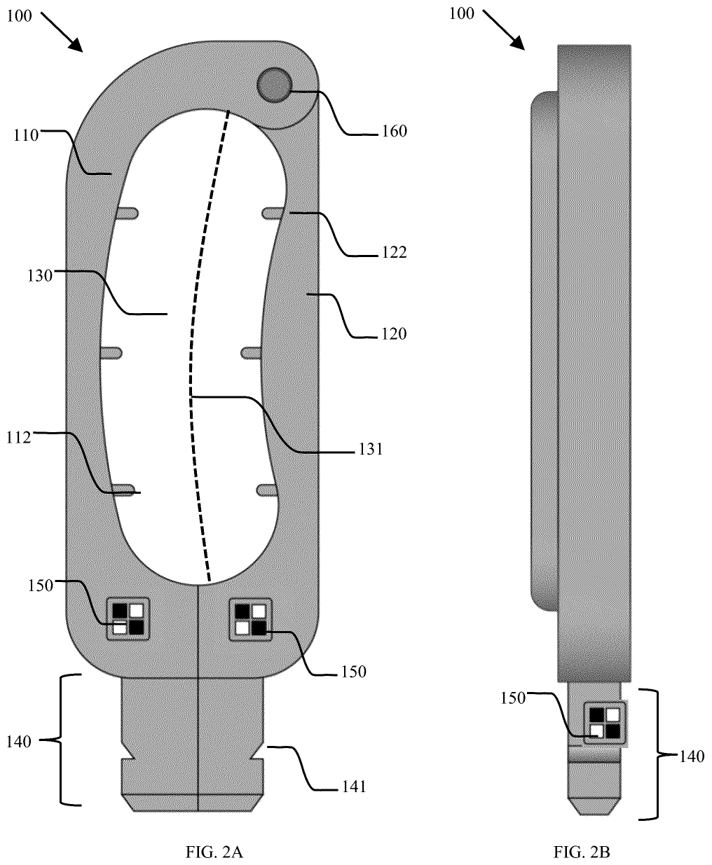

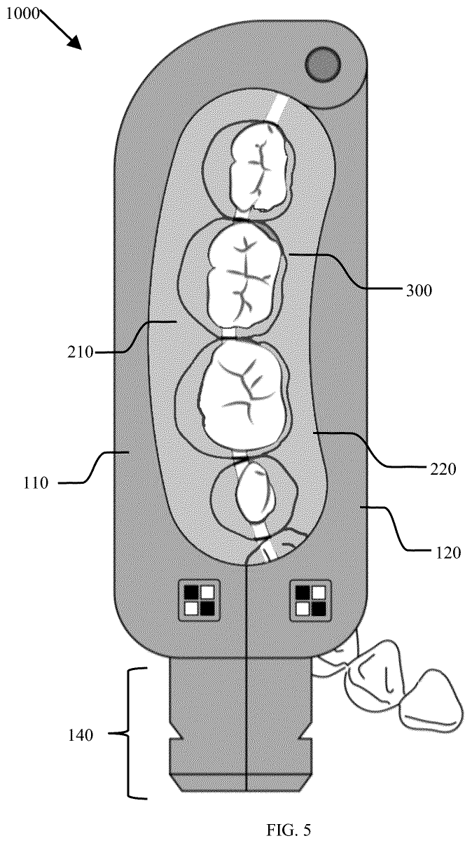

In some embodiments, the first chassis 110 and the second chassis 120 form a cavity 130 when the system is in a closed state. In some embodiments, a first portion of the perimeter of the cavity 130 bound by the first chassis 110 is greater than a second portion of the perimeter of the cavity 130 bound by the second chassis 120. In some embodiments, a first portion of the perimeter of the cavity 130 bound by the first chassis 110 is less than a second portion of the perimeter of the cavity 130 bound by the second chassis 120. In some embodiments, an entirety of the cavity 130 is bounded by the first chassis 110 and the second chassis 120. In some embodiments, at most a portion of the cavity 130 is bounded by the first chassis 110 and the second chassis 120. In some embodiments, the cavity 130 has a cross-section shape comprising a circle, a square, a rectangle, an ellipsoid, an obround, or any combination thereof. In some embodiments, the cross-sectional shape of the cavity 130 is a cross-sectional shape of the cavity 130 as viewed from the top of the primary tooth clamping system 1000, as seen in FIGS. 1A and 2A. In some embodiments, the cross-sectional shape of the cavity 130 is consistent between a top face of the chassis 100 to a bottom surface of the chassis 100. In some embodiments, the cross-sectional shape of the cavity 130 is prismatic. In some embodiments, the cross-sectional shape of the cavity 130 varies as a function of a distance from the top surface of the chassis 100 to the bottom surface of the chassis 100. In some embodiments, the cavity 130 has an arcuate cross-sectional shape. In some embodiments, per FIGS. 1A and 2A, the cavity 130 has arcuate and obround cross-sectional shape. In some embodiments, the cavity 130 has an irregular cross-section shape. In some embodiments, an inner surface of the cavity 130 is rounded. In some embodiments, an inner surface of the cavity 130 is rounded to prevent damage to the mouth of the patient. In some embodiments, an inner surface of the cavity 130 is a half round. In some embodiments, an outer edge of the first chassis 110, the second chassis 120, or both comprises a fillet or a chamfer. In some embodiments, an outer edge of the first chassis 110, the second chassis 120, or both comprises a fillet or a chamfer to prevent injury to the mouth of the patient. In some embodiments, per FIG. 5, the cavity 130 is configured to receive one or more patient teeth 300. In some embodiments, the size, shape, or both cavity 130 enables the cavity 130 to receive one or more patient teeth 300.

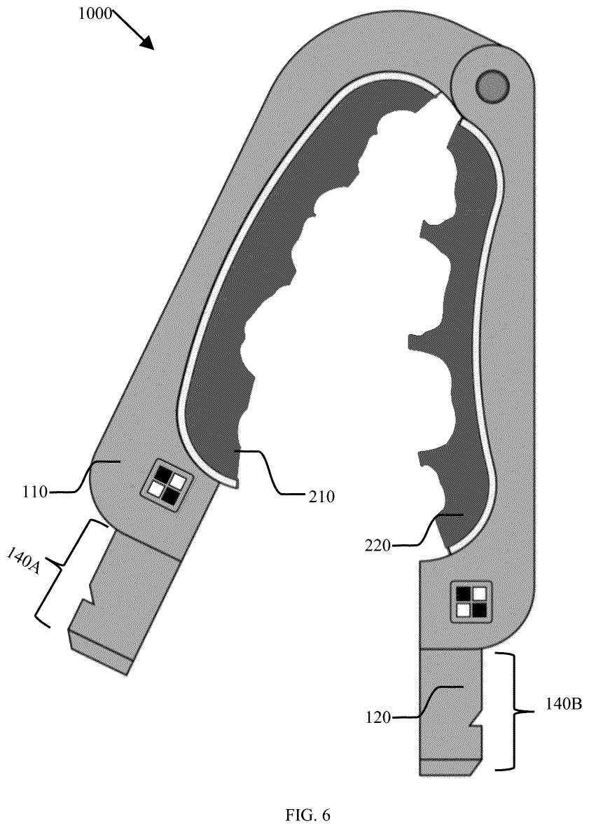

In some embodiments, per FIG. 6, a proximal portion of the first chassis 140A and a proximal portion of the second chassis 140B form a gantry 140 when the system is in the closed state. In some embodiments, at least part of the proximal portion of the first chassis 110 contacts at least a part of the proximal portion of the second chassis 120 when the system is in the closed state. In some embodiments, at least part of the first chassis 110 outside the proximal portion contacts at least a part of the second chassis 120 outside the proximal portion when the system is in the closed state. In some embodiments, the proximal portion of the first chassis 110 contacts at least a portion of the proximal portion of the second chassis 120 when the system is in the closed state. In some embodiments, the gantry 140 has a cross sectional shape comprising a circle, a triangle, a rectangle, a square, a polygon, or any combination thereof. In some embodiments, the gantry 140 is configured to couple to a dental cutting machine. In some embodiments, per FIG. 2A, the gantry 140 comprises a coupling notch to couple the primary tooth clamping system 1000 to the dental cutting machine. In some embodiments, the first chassis 110, the second chassis 120, or both comprise the coupling notch 141. Alternatively, in some embodiments, the gantry 140 comprises a pin, a snap, a magnet, a groove, a thread, or any combination thereof to couple to a dental cutting machine. Alternatively, in some embodiments, the first chassis 110, the second chassis 120, or both, comprise a pin, a snap, a magnet, a groove, a thread, or any combination thereof to couple to a dental cutting machine. In some embodiments, the dental cutting machine is an automated dental cutting machine.

In some embodiments, a surface of first chassis 110, the second chassis 120, or both, comprise a fiducial 150. In some embodiments, the fiducial 150 enables an association between the chassis 100, the cavity 130, or both and the gantry 140. In some embodiments, a surface of first chassis 110 and a surface of the second chassis 120 comprise the fiducial 150. In some embodiments, a surface of first chassis 110, the second chassis 120, or both, comprise two or more fiducials 150. Per FIGS. 1A-2B, in some embodiments, the fiducial 150 is located between the gantry 140 and the cavity 130 on the first chassis 110, the second chassis 120, or both. In some embodiments, the fiducial 150 is placed proximal to the gantry 140 such that any flexing of the chassis 100 does not interfere with the association between the chassis 100, the cavity 130, or both and the gantry 140. Further as shown, in some embodiments, the fiducial 150 is located on a mesial area the gantry 140 on of the first chassis 110, the second chassis 120, or both. In some embodiments, the position of the fiducial 150 the mesial area the gantry 140 on of the first chassis 110, the second chassis 120, or both, enables association between the chassis 100, the cavity 130, or both and the gantry 140 about a second plane. In some embodiments, the fiducial 150 is placed relative to the cavity 130, the gantry 140, or both with a set tolerance. In some embodiments, the fiducial 150 on the first chassis 110 is placed relative to the fiducial 150 on the second chassis 120 with a set tolerance. In some embodiments, the tolerance of the location of the fiducial 150 enables a more precise association between the chassis 100, the cavity 130, or both and the gantry 140 about a second plane.

In some embodiments, the cavity 130 is configured to receive an impression media 200. In some embodiments, the cavity 130 is configured to receive the impression media 200, when the primary tooth clamping system 1000 is in the closed state. In some embodiments, per FIG. 2A, an interior surface of the cavity 130 comprises a pin 112 to receive the impression media 200. In some embodiments, the interior surface of the cavity 130 comprises 1, 2, 3, 4, 5, 6, 7, 8, 9, 10, 12, 14, 16, or more pins 112. In some embodiments, a surface of the first chassis 110, the second chassis 120 or both that define the cavity 130 comprises the pin 112. Alternatively, in some embodiments, the cavity 130 comprises a groove, a slot, a cavity 130, a surface texture, a clamp, or any combination thereof to receive the impression media 200. In some embodiments, the pin 112, the groove, the slot, the cavity 130, the surface texture, the clamp, or any combination thereof prevent the impression media 200 from translating with respect to the cavity 130 during use. In some embodiments, the pin 112, the groove, the slot, the cavity 130, the surface texture, the clamp, or any combination thereof prevent the impression media 200 from translating with respect to the cavity 130 upon hardening.

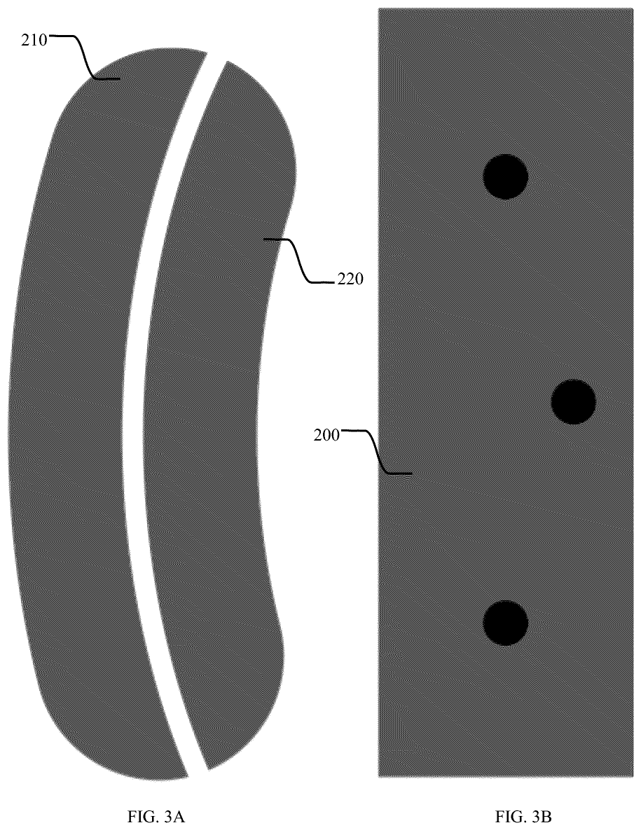

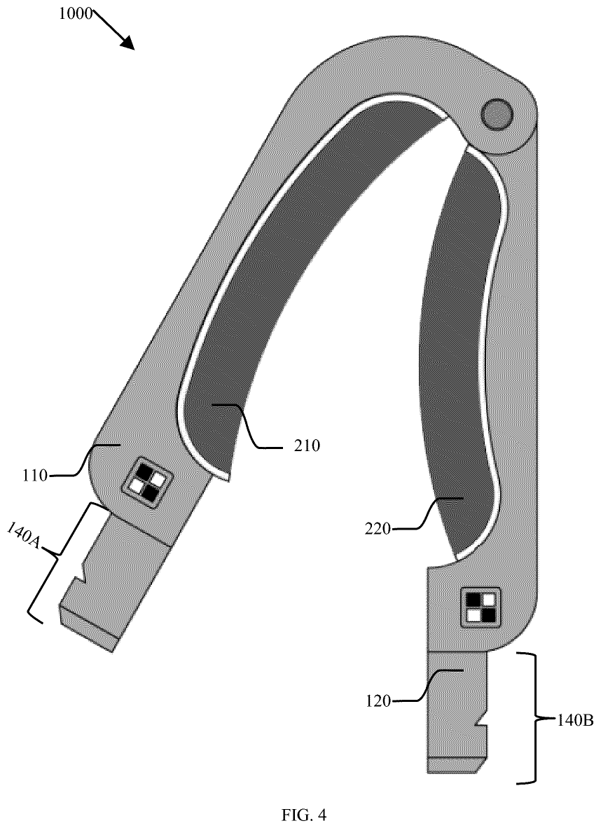

In some embodiments, per FIGS. 3A and 4, the impression media 200 comprises a primary impression media portion 210 and a secondary impression media portion 220. Alternatively, in some embodiments, the impression media 200 comprises 3, 4, 5, 6, 7, 8, 9, 10, or more impression media 200 portions. In some embodiments, the cavity 130 receives the impression media 200 such that at least a portion of the primary impression media portion 210 contacts at least a portion of the secondary impression media portion 220. In some embodiments, the cavity 130 receives the impression media 200 such that at least a portion of the primary impression media portion 210 is separated from at least a portion of the secondary impression media portion 220 In some embodiments, the first chassis 110 receives at least a portion of the primary impression media portion 210, the secondary impression media portion 220, or both. In some embodiments, the second chassis 120 receives at least a portion of the primary impression media portion 210, the secondary impression media portion 220, or both. In some embodiments, the first chassis 110 receives at most a portion of the primary impression media portion 210, the secondary impression media portion 220, or both. In some embodiments, the second chassis 120 receives at most a portion of the primary impression media portion 210, the secondary impression media portion 220, or both. In some embodiments, a volume of the primary impression media portion 210 is greater than a volume of the secondary impression media portion 220. In some embodiments, a volume of the primary impression media portion 210 is less than a volume of the secondary impression media portion 220. In some embodiments, a volume of the primary impression media portion 210 is approximately equal to a volume of the secondary impression media portion 220. In some embodiments, at least one of the primary impression media portion 210 and the secondary impression media portion 220 has a prismatic shape.

In some embodiments, the impression media 200 is configured to form a direct impression of the one or more patient teeth 300. In some embodiments, per FIG. 5, the impression media 200 is configured to form and maintain a shape of a direct impression of the one or more patient teeth 300. In some embodiments, the impression material is polymer.

### Secondary Tooth Clamps and Tooth Clamp System

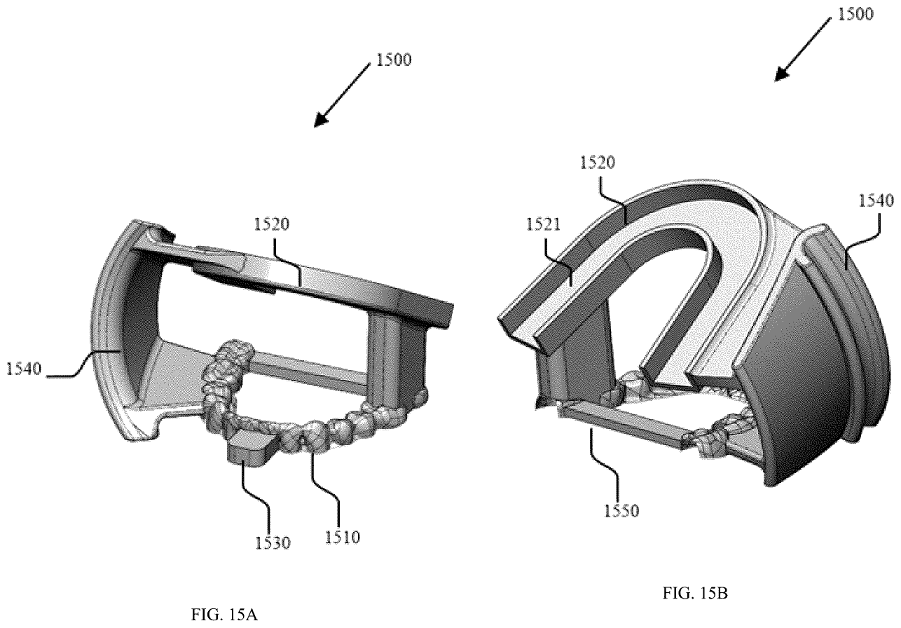

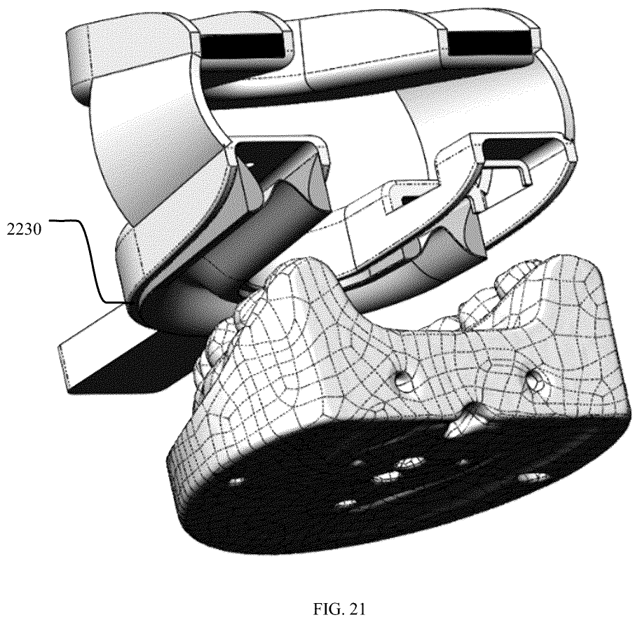

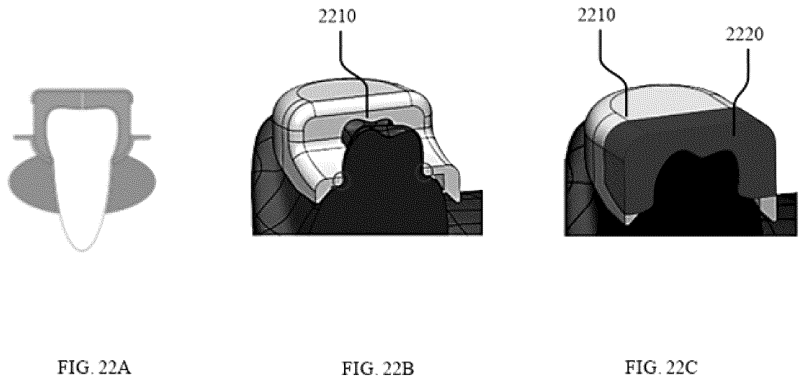

Another aspect provided herein, per FIGS. 15A and 15B, is a secondary tooth clamp 1500 for performing a dental procedure on a subject. In some embodiments, the secondary tooth clamp 1500 comprises a first arch segment 1510, a second arch segment 1520, a cheek retracting surface 1540, and a coupling mechanism 1530. In some embodiments, the first arch segment 1510 is an maxillary arch segment and wherein the second arch segment 1520 is a mandibular arch segment. In some embodiments, the first arch segment 1510 is a mandibular arch segment and wherein the second arch segment 1520 is an maxillary arch segment. In some embodiments, the secondary tooth clamp 1500 further comprises a tongue blocking portion 1550. In some embodiments, the tongue blocking portion 1550 positions the subjects tongue in such a way to prevent debris impact during operation on a tooth. In some embodiments, the tongue blocking portion 1550 extends from at least a portion of the first arch segment 1510, at least a portion of the second arch segment 1520, or both. In some embodiments, per FIG. 21, the secondary tooth clamp 1500 further comprises a gasket 2310 coupled to at least a portion of the first arch segment 1510. In some embodiments, the gasket 2310 is configured to suction the secondary tooth clamp 1500 to the tooth of the subject. In some embodiments, the secondary tooth clamp 1500 is formed by 3D printing, injection molding, or both. In some embodiments, the secondary tooth clamp 1500 further comprises an indicator that the first arch segment 1510 has fully coupled to the first row of teeth of the subject.

In some embodiments, at least a portion of the first arch segment 1510 comprises a negative imprint. In some embodiments, at least a portion of the first arch segment 1510 comprises a negative imprint corresponding with at least a portion of a first row of teeth of the subject. In some embodiments, the negative imprint of the tooth of the subject is determined based on a dental arch anatomy scan. In some embodiments, the first arch segment 1510 has a procedure access opening therethrough. In some embodiments, a wall of the procedure access opening is shaped based on negative imprint of a treatment tooth of the subject. In some embodiments, the procedure access opening comprises a primary procedure access opening proximal to tooth of the subject and a secondary procedure access opening proximal to tooth of the subject. In some embodiments, a wall of the primary procedure access opening is shaped based on negative imprint of a treatment tooth of the subject. In some embodiments, the secondary procedure access opening has a width, length, or both greater than a width, length, or both of the primary procedure access. In some embodiments, at least a portion of the first arch segment 1510 is removable from another portion of the first arch segment 1510.

In some embodiments, the second arch segment 1520 engages at least a portion of a second row of teeth of the subject opposite the first row of teeth. In some embodiments, the second arch segment 1520 comprises an arcuate channel. In some embodiments, the arcuate channel provides a surface for the subject to rest a maxillary arch or a mandibular arch of a subject. In some embodiments, the arcuate channel provides a surface for the subject to an arch opposing the tooth to be operated on. In some embodiments, at least a portion of the arcuate channel is padded.

In some embodiments, the cheek retracting surface 1540 is coupled to at least a portion of the first arch segment 1510, at least a portion of the second arch segment 1520, or both. As shown, the cheek retracting surface 1540 is non-interrupted. As shown, the cheek retracting surface 1540 is cylindrical. Alternatively, in some embodiments, the cheek retracting surface 1540 has one or more holes therethrough. Alternatively, in some embodiments, the cheek retracting surface 1540 is cylindrical or conical. Further, as shown the cheek retracting surface 1540 comprises a protrusion configured to contact at least a portion of the lip of the subject.

In some embodiments, the coupling mechanism 1530 extends from at least a portion of the first arch segment 1510, at least a portion of the second arch segment 1520, or both. In some embodiments, the coupling mechanism 1530 extends from a mesial portion of the first arch segment 1510, a mesial portion of the second arch segment 1520, or both. In some embodiments, the coupling mechanism 1530 couples to a dental cutting machine. In some embodiments, the coupling mechanism 1530 further comprises a fiducial. In some embodiments, the coupling mechanism 1530 is a rigid coupling mechanism 1530. In some embodiments, the coupling mechanism 1530 comprises a pin, a threaded feature, a clip, a magnet, a nut, a bolt, a catch, a clasp, or any combination thereof.

Another aspect provided herein is a secondary tooth clamp 1500 system for performing a dental procedure on a subject, the tooth clamp system comprising the secondary tooth clamp 1500 herein, and a gum support. In some embodiments, the gum support is coupled to at least a portion of the first arch segment 1510 of the tooth clamp, at least a portion of the second arch segment 1520 of the tooth clamp, or both.

### Tertiary Tooth Clamp System

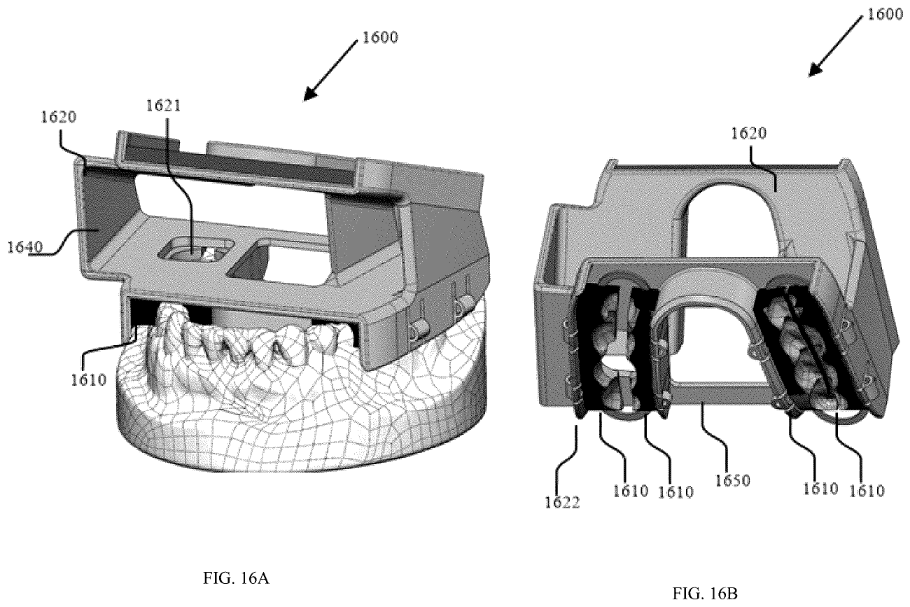

Another aspect provided herein, per FIGS. 16A and 16B, is a tertiary tooth clamp system 1600 for performing a dental procedure on a subject. In some embodiments, the tertiary tooth clamp system 1600 comprises a clamp insert 1610 and a clamp frame 1620. In some embodiments, the tertiary tooth clamp system 1600 comprises 1, 2, 3, 4, or more clamp inserts 1610. In some embodiments, two or more of the clamp inserts 1610 have different elasticity, pliability, ductility, or any combination thereof.

In some embodiments, the clamp insert 1610, the clamp frame 1620, or both are formed by 3D printing, injection molding, or both. In some embodiments, the clamp insert 1610, the clamp frame 1620, or both, is reusable. In some embodiments, the clamp insert 1610, the clamp frame 1620, or both, is formed of a rigid material. In some embodiments, the clamp insert 1610, the clamp frame 1620, or both, is formed of an at least partially compliant material. In some embodiments, as shown, the tertiary tooth clamp system 1600 comprises a first clamp insert 1610 for two or more teeth on the subject's left side and a second clamp insert 1610 for two or more teeth on the subject's right side. In some embodiments, as shown, the clamp insert 1610 has a mesial portion and a distal portion, wherein the mesial and distal portions are interconnected. In some embodiments, the mesial and distal portions are interconnected by a flexible member. In some embodiments, the mesial and distal portions are separate and distinct. In some embodiments, the mesial and distal portions are rigidly connected.

In some embodiments, the clamp insert 1610 has one or more interior surfaces. In some embodiments, at least a portion of the one or more interior surfaces is shaped with a negative imprint of a tooth of the subject. In some embodiments, the negative imprint of the tooth of the subject is determined based on a dental arch anatomy scan.

In some embodiments, the clamp frame 1620 comprises a clamp insert coupling 1622, a cheek retracting surface, a second arch segment, and a coupling mechanism. In some embodiments, the clamp frame 1620 further comprises a tongue blocking portion 1650 extending from at least a portion of the first arch segment, at least a portion of the second arch segment, or both. In some embodiments, the clamp frame 1620 further comprises an indicator that the first arch segment has fully coupled to the first row of teeth of the subject. As shown, the cheek retracting surface 1640 is cylindrical. Alternatively, in some embodiments, the cheek retracting surface 1640 has one or more holes therethrough. Alternatively, in some embodiments, the cheek retracting surface 1640 is cylindrical or conical. Further, as shown the cheek retracting surface 1640 comprises a protrusion configured to contact at least a portion of the lip of the subject. In some embodiments, the first arch segment has a procedure access opening 1621 therethrough.

In some embodiments, a clamp insert coupling 1622 receives the clamp insert 1610. In some embodiments, the clamp insert 1610 comprises a compressible portion. In some embodiments, the second arch segment comprises an arcuate channel. In some embodiments, the second arch segment is a mandibular arch segment. In some embodiments, the second arch segment is an maxillary arch segment. In some embodiments, the arcuate channel provides a surface for the subject to rest a maxillary arch or a mandibular arch of a subject. In some embodiments, the arcuate channel provides a surface for the subject to an arch opposing the tooth to be operated on. In some embodiments, at least a portion of the arcuate channel is padded.

In some embodiments, the coupling mechanism removably couples the clamp frame 1620 to a dental cutting machine. In some embodiments, the coupling mechanism further comprises a fiducial. In some embodiments, the coupling mechanism is a rigid coupling mechanism. In some embodiments, the coupling mechanism comprises a pin, a threaded feature, a clip, a magnet, a nut, a bolt, a catch, a clasp, or any combination thereof.

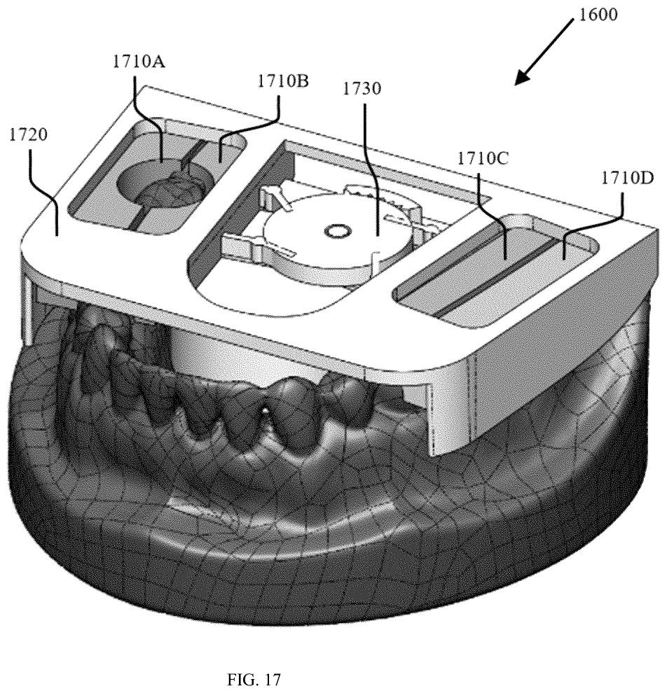

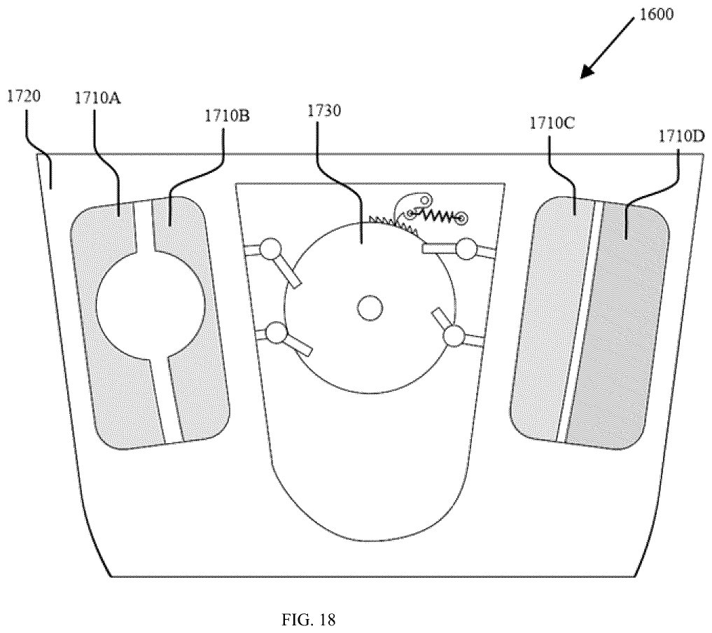

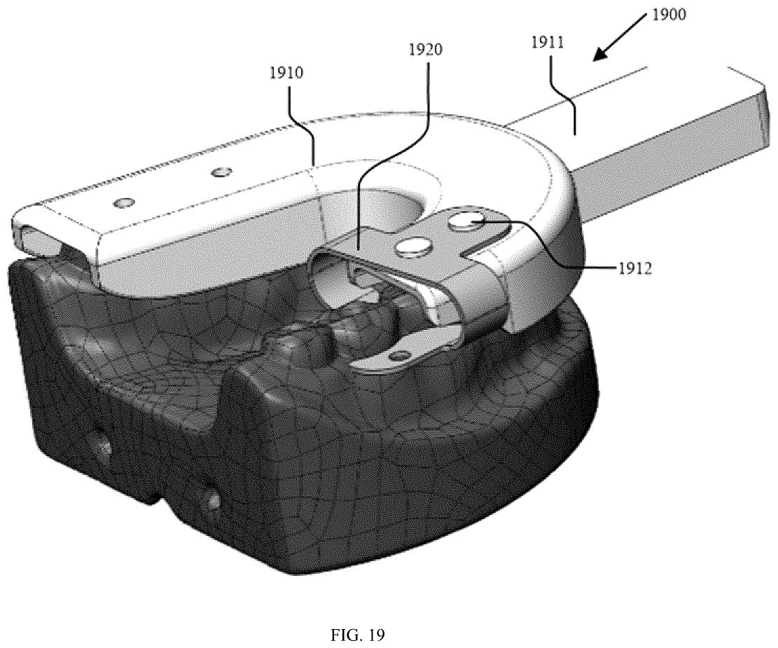

In some embodiments, per FIGS. 17 and 18, the tertiary tooth clamp system 1600 further comprises a tightening mechanism 1730 compressing the compressible portion to clamp the tertiary tooth clamp system 1600 to the tooth of a subject. In some embodiments, the tightening mechanism 1730 comprises a cam, a slide, a wedge, a gear, a pulley, a worm drive, a bar linkage, a ratchet, a spring, a lever a spring, or any combination thereof. In some embodiments, the tertiary tooth clamp system 1600 further comprises a gum support removably coupled to the clamp frame 1620. In some embodiments, the tertiary tooth clamp system 1600 comprises a first clamp insert 1710A, a second clamp insert 1710B, a third clamp insert 1710C, and a fourth clamp insert 1710D. In some embodiments, two or more of the first clamp insert 1710A, the second clamp insert 1710B, the third clamp insert 1710C, and the fourth clamp insert 1710D have different elasticity, pliability, ductility, or any combination thereof. In some embodiments, as shown, the third clamp insert 1710C and the fourth clamp insert 1710D have a higher elasticity, pliability, ductility, or any combination thereof than the first clamp insert 1710A and the second clamp insert 1710B.

### Quaternary Tooth Clamp System

Another aspect provided herein is a quaternary tooth clamp system 1900 for performing a dental procedure on a subject. In some embodiments, the quaternary tooth clamp system 1900 comprises a clamp frame 1910, and a spring clip 1920. In some embodiments, the clamp system further comprises an impression material in the clamp frame 1910.

In some embodiments, the clamp frame 1910 comprises a first arch segment, a coupling mechanism 1911, and a first spring clip fastener 1912. In some embodiments, as shown, the clamp frame 1910 comprises three first spring clip fasteners 1912. Alternatively, in some embodiments the clamp frame 1910 comprises 1, 2, 3, 4, 5, 6, 7, 8, 9, 10, or more first spring clip fasteners 1912. In some embodiments, the clamp frame 1910 is formed by 3D printing, injection molding, or both. In some embodiments, the clamp frame 1910 further comprises a tongue blocking portion extending from at least a portion of the first arch segment. In some embodiments, per FIG. 21, the clamp frame 1910 further comprises a gasket 2310 coupled to at least a portion of the arch overlay surface. In some embodiments, the gasket 2310 is configured to suction the tooth clamp to the tooth of the subject.

In some embodiments, the first arch segment comprises a procedure access cavity therethrough. In some embodiments, at least a portion of the first arch segment comprises a negative imprint of a tooth of the subject. In some embodiments, the first arch segment is an maxillary arch segment. In some embodiments, the first arch segment is a mandibular arch segment.

In some embodiments, the coupling mechanism 1911 extends from at least a portion of the first arch segment. In some embodiments, the coupling mechanism 1911 couples to a dental cutting machine. In some embodiments, the coupling mechanism 1911 further comprises a fiducial. In some embodiments, the coupling mechanism 1911 is a rigid coupling mechanism 1911. In some embodiments, the coupling mechanism 1911 comprises a pin, a threaded feature, a clip, a magnet, a nut, a bolt, a catch, a clasp, or any combination thereof.

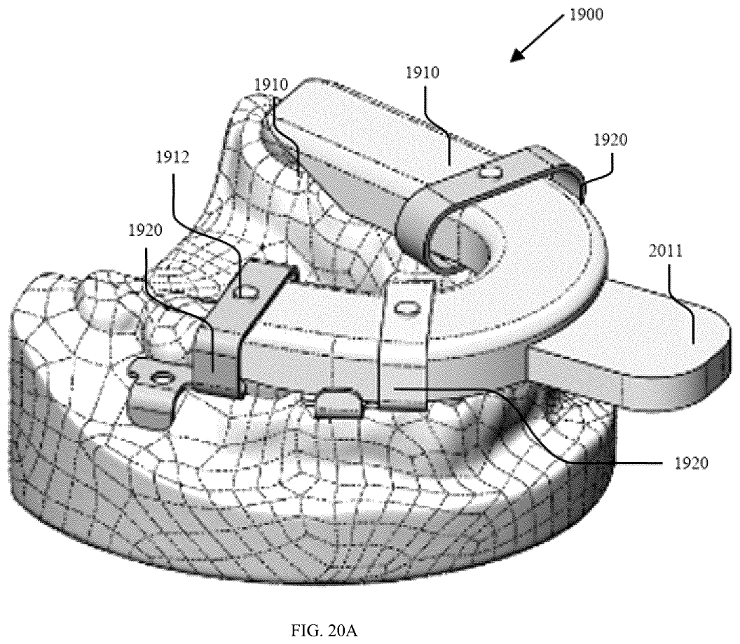

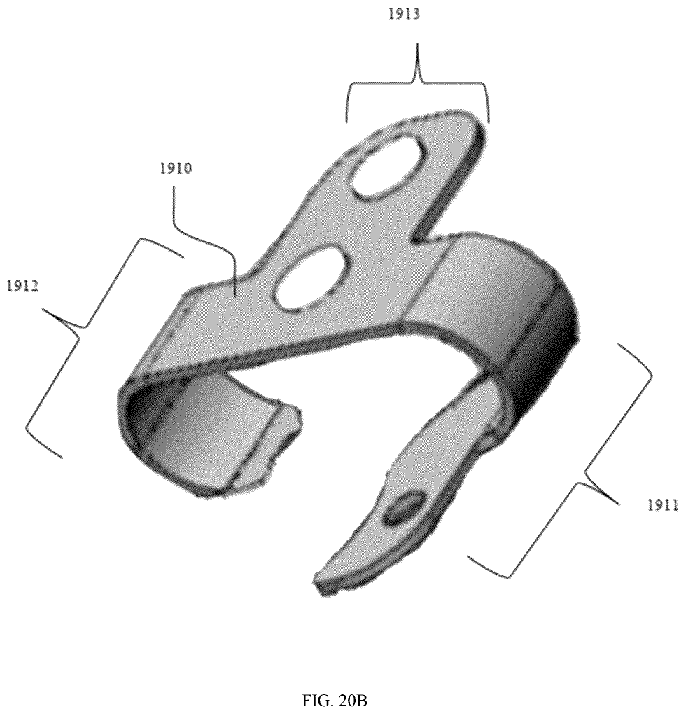

In some embodiments, per FIG. 20B, the spring clip 1920 comprises a first clip segment 1911, a second clip segment 1912, and a third clip segment 1913. In some embodiments, the spring clip 1920 is configured to removably couple to the clamp frame 1910. In some embodiments, at least a portion of the distal edge of the first clip segment 1911 has a concave shape. In some embodiments, at least a portion distal edge of the second clip segment 1912 has a concave shape. In some embodiments, the third clip segment 1913 is between the first clip segment 1911 and the second clip segment 1912. In some embodiments, the third clip segment 1913 comprises a second spring clip fastener 1914 that removably couples to the first spring clip fastener 1912. In some embodiments, as shown, the third clip segment 1913 comprises one second spring clip fastener 1914. Alternatively in some embodiments, the third clip segment 1913 comprises 1, 2, 3, 4, 5, 6, or more second spring clip fasteners 1914.

### Method for Performing a Dental Procedure

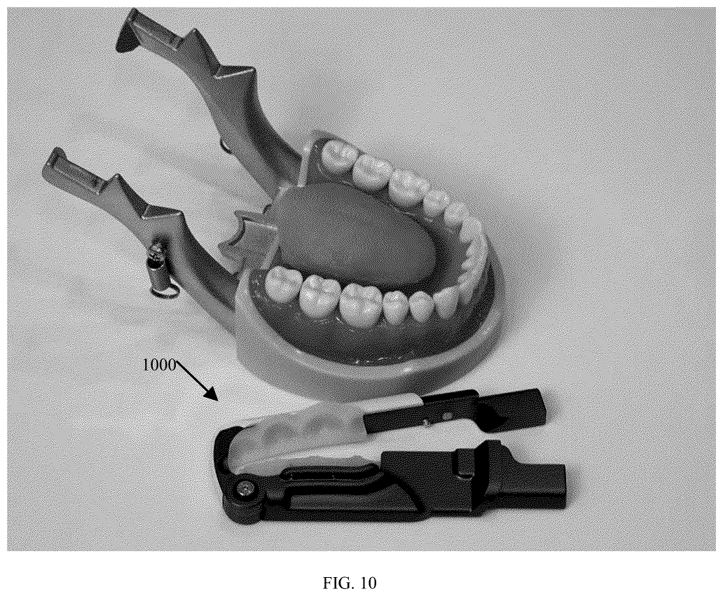

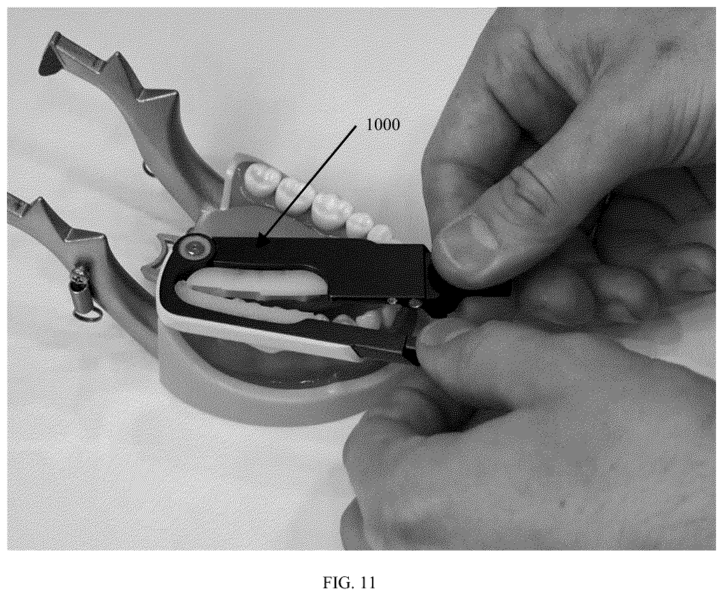

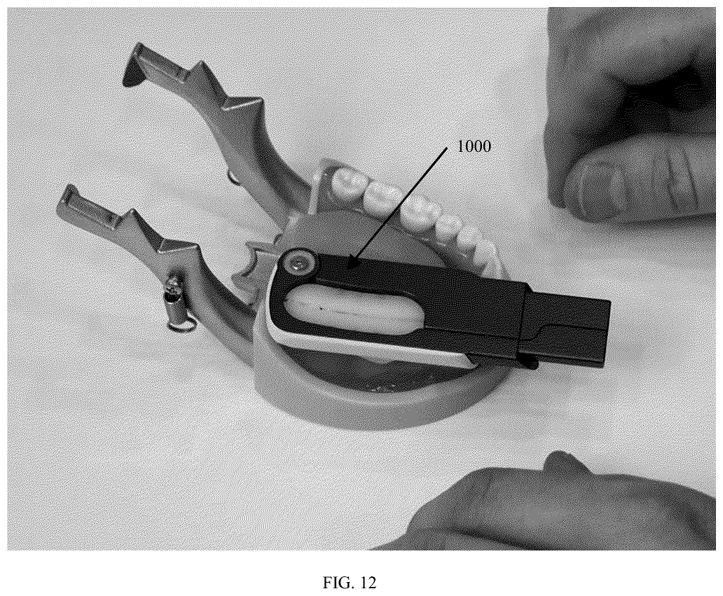

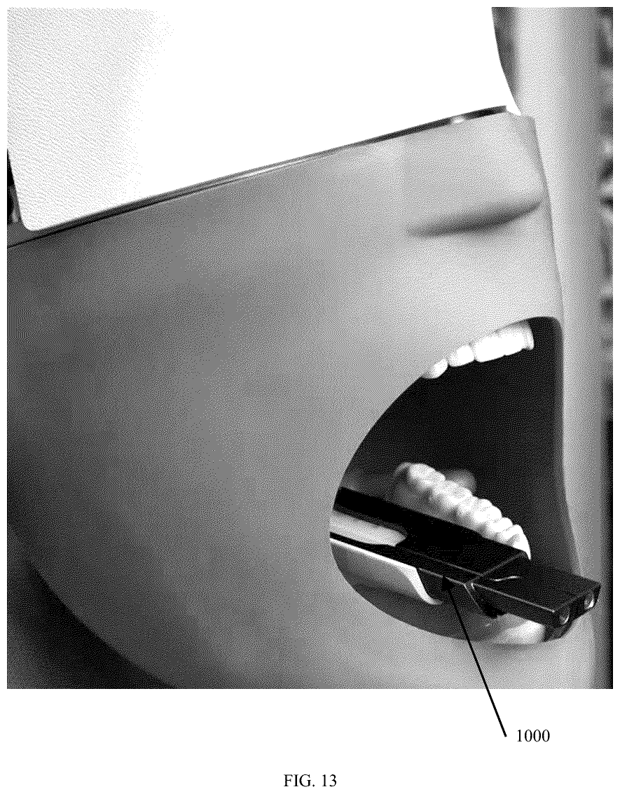

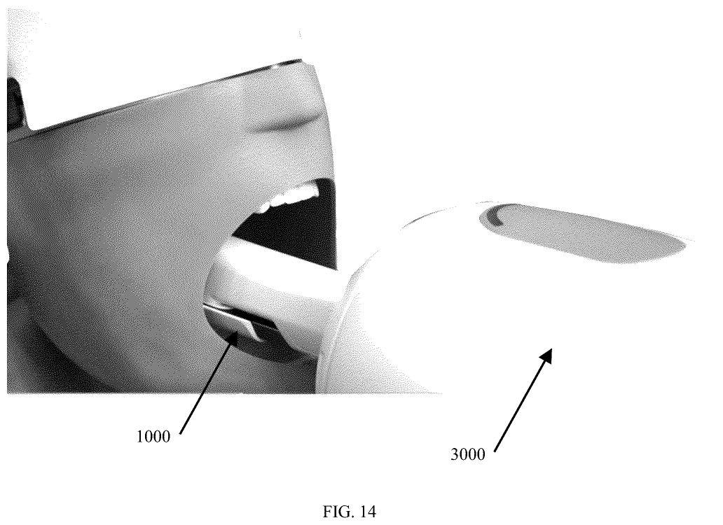

Another aspect provided herein, per FIGS. 10-14 is a method for performing a dental procedure. In some embodiments, the method comprises: providing the tooth 300 clamping system 1000 herein, per FIG. 10; performing a dental arch anatomy scan of a patient; inserting the primary impression media portion 210 and the secondary impression media portion 220 into the cavity 130; installing the system into the mouth of the patient by clamping two or more teeth 300 of the patient between at least a portion of the primary impression media portion 210 and the secondary impression media portion 220 until the system is in the closed state, per FIGS. 11 and 12; removing the system from the mouth of the patient once the primary impression media portion 210 and the secondary impression media portion 220 have hardened; performing an impression scan of the fiducial 150 and one or more surfaces of the primary impression media portion 210 and the secondary impression media portion 220; overlaying the dental arch anatomy scan and the impression scan to form an overlaid model; determining a cut path based on the overlaid model; reinstalling the system into the mouth of the patient, per FIG. 13; coupling the gantry 140 to a dental cutting machine 3000, per FIG. 14; and cutting at least a portion of one or more of the two or more teeth 300 of the patient, based on the cut path.

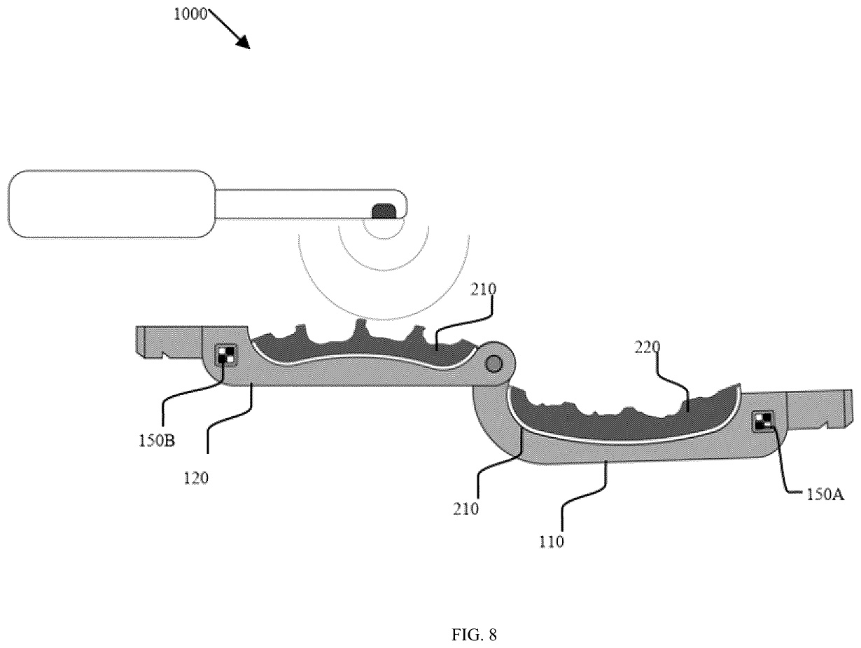

In some embodiments, per FIG. 8, the dental arch anatomy scan, the impression scan, or both is performed by any two-dimensional or three-dimensional scanner. In some embodiments, performing the impression scan comprises forming a three dimensional relationship between fiducial 150 and the one or more surfaces of the primary impression media portion 210 and the secondary impression media portion 220. In some embodiments, performing the impression scan comprises forming a three dimensional relationship between a primary fiducial 150A on the first chassis 110, a secondary fiducial 150B on the second chassis 120, and the one or more surfaces of the primary impression media portion 210 and the secondary impression media portion 220. In some embodiments, the method further comprises inserting 3, 4, 5, 6, 7, 8, 9, 10 or more impression media 200 portions into the cavity 130. In some embodiments, installing the system into the mouth of the patient is performed by a caregiver, a dental cutting machine 3000 or both. In some embodiments, removing the system from the mouth of the patient is performed by a caregiver, a dental cutting machine 3000 or both. In some embodiments, the dental arch anatomy scan is overlaid with the impression scan based on the three dimensional relationship between the fiducial 150 and the one or more surfaces of the primary impression media portion 210 and the secondary impression media portion 220.

In some embodiments, performing of the impression scan of the fiducial 150 and one or more surfaces of the primary impression media portion 210 and the secondary impression media portion 220, determining the three dimensional relationship between the fiducial 150 and the one or more surfaces of the primary impression media portion 210 and the secondary impression media portion 220, overlaying the dental arch anatomy scan and the impression scan to form an overlaid model, or any combination thereof enable the determination of the cut path with greater accuracy. In some embodiments, reinstalling the system into the mouth of the patient is performed by a caregiver, a dental cutting machine 3000 or both. In some embodiments, cutting the teeth 300 by the dental cutting machine 3000 comprises cutting the teeth with a drill, with a waterjet, with a laser, with a saw, or any combination thereof. In some embodiments, the dental cutting machine 3000 is an automated dental cutting machine. In some embodiments, the dental arch anatomy scan, the impression scan, or both have a set resolution. As such, the components, features, method steps, or any combination thereof herein enable dental treatments with higher accuracy by ensuring that a relationship between a location on a tooth to the fiducial, between the fiducial and the cut path, or both are fully determined and accounted for.

### Kit for Performing a Dental Procedure

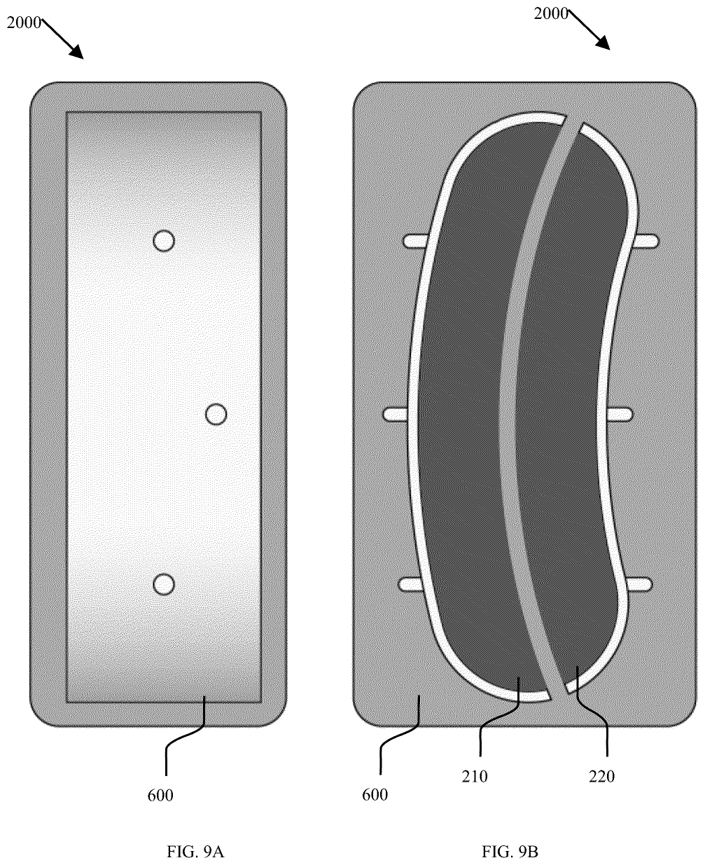

Another aspect provided herein is a kit 2000 for performing a dental procedure. In some embodiments, the kit comprises the tooth clamping system provided herein and a packaging 600 for the primary impression media portion, the secondary impression media portion, or both. FIGS. 9A and 9B show an exemplary packaging 600. In some embodiments, the packaging 2000 separates at least a portion of the primary impression media portion 210 from the secondary impression media portion 220. In some embodiments, the packaging 600 prevents the primary impression media portion 210, the secondary impression media portion 220, or both from hardening during storage and/or transit. In some embodiments, the kit 2000 further comprises an instruction manual.

### Dental Cutting Machine

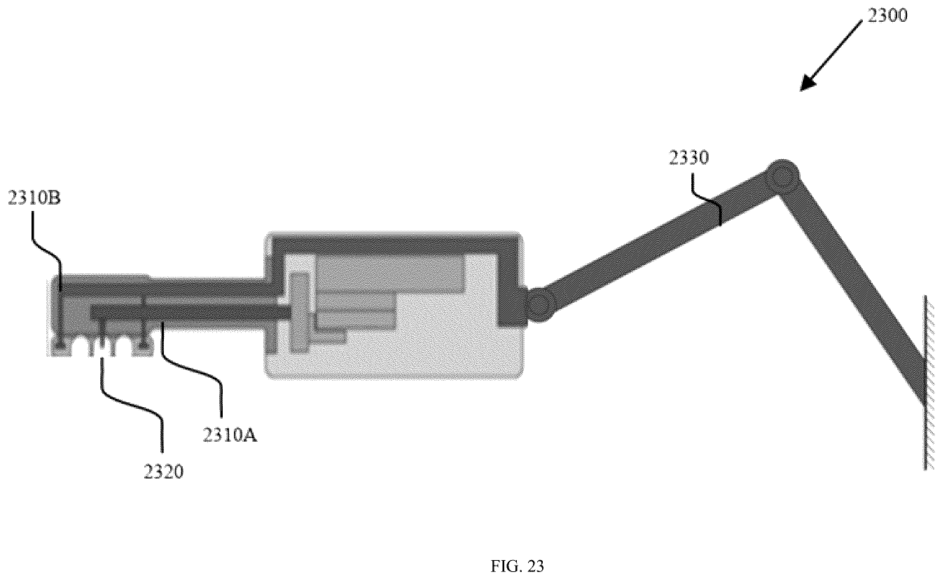

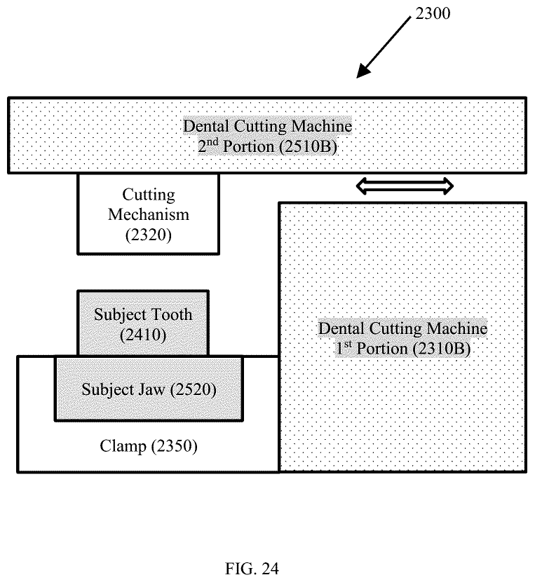

In some embodiments, per FIGS. 23 and 24, the tooth clamping systems herein are configured to couple to, and be used in parallel, with a dental cutting machine 2300. In some embodiments, the dental cutting machine 2300 comprises a robotic system, a computer controlled system, or both.

In some embodiments, the dental cutting machine 2300 comprises a first portion 2310A and a second portion 2310B. In some embodiments, the second portion 2310B translates and/or rotates in one or more directions with respect to the first portion 2310A. In some embodiments, the first portion of the dental cutting machine 2310A couples to the clamps 2350 provided herein, which attach to a jaw of a subject 2410. In some embodiments, the second portion of the dental cutting machine 2320 moves relative to the first portion 2310 to perform the dental procedure on the subject's tooth 2410 with a cutting mechanism 2320. In some embodiments, the dental cutting machine 2300 is mounted to a rigid base, a wall, a cart, or any combination thereof. In some embodiments, the dental cutting machine 2300 is mounted to a rigid base, a wall, a cart, or any combination thereof by a translatable arm 2340. In some embodiments, the dental cutting machine 2300 comprises a three-dimensional scanner. In some embodiments, the tooth clamp systems herein ensure precision of dental procedures by preventing or reducing relative movement between the subject and the first portion of the dental cutting machine 2310.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Computing System

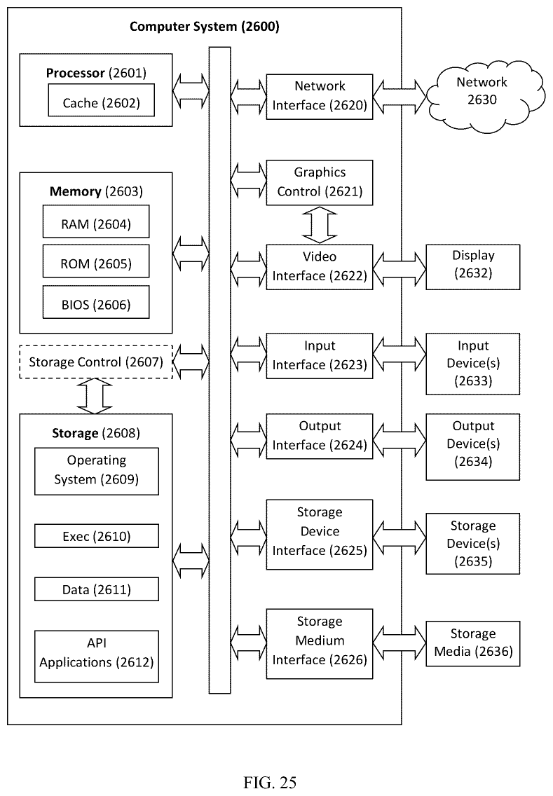

Referring to FIG. 25, a block diagram is shown depicting an exemplary machine that includes a computer system 2500 (e.g., a processing or computing system) within which a set of instructions can execute for causing a device to perform or execute any one or more of the aspects and/or methodologies for static code scheduling of the present disclosure. The components in FIG. 25 are examples only and do not limit the scope of use or functionality of any hardware, software, embedded logic component, or a combination of two or more such components implementing particular embodiments.

Computer system 2500 may include one or more processors 2501, a memory 2503, and a storage 2508 that communicate with each other, and with other components, via a bus 2540. The bus 2540 may also link a display 2532, one or more input devices 2533 (which may, for example, include a keypad, a keyboard, a mouse, a stylus, etc.), one or more output devices 2534, one or more storage devices 2535, and various tangible storage media 2536. All of these elements may interface directly or via one or more interfaces or adaptors to the bus 2540. For instance, the various tangible storage media 2536 can interface with the bus 2540 via storage medium interface 2526. Computer system 2500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 2500 includes one or more processor(s) 2501 (e.g., central processing units (CPUs) or general purpose graphics processing units (GPGPUs)) that carry out functions. Processor(s) 2501 optionally contains a cache memory unit 2502 for temporary local storage of instructions, data, or computer addresses. Processor(s) 2501 are configured to assist in execution of computer readable instructions. Computer system 2500 may provide functionality for the components depicted in FIG. 25 as a result of the processor(s) 2501 executing non-transitory, processor-executable instructions embodied in one or more tangible computer-readable storage media, such as memory 2503, storage 2508, storage devices 2535, and/or storage medium 2536. The computer-readable media may store software that implements particular embodiments, and processor(s) 2501 may execute the software. Memory 2503 may read the software from one or more other computer-readable media (such as mass storage device(s) 2535, 2536) or from one or more other sources through a suitable interface, such as network interface 2520. The software may cause processor(s) 2501 to carry out one or more processes or one or more steps of one or more processes described or illustrated herein. Carrying out such processes or steps may include defining data structures stored in memory 2503 and modifying the data structures as directed by the software.

The memory 2503 may include various components (e.g., machine readable media) including, but not limited to, a random access memory component (e.g., RAM 2504) (e.g., static RAM (SRAM), dynamic RAM (DRAM), ferroelectric random access memory (FRAM), phase-change random access memory (PRAM), etc.), a read-only memory component (e.g., ROM 2505), and any combinations thereof. ROM 2505 may act to communicate data and instructions unidirectionally to processor(s) 2501, and RAM 2504 may act to communicate data and instructions bidirectionally with processor(s) 2501. ROM 2505 and RAM 2504 may include any suitable tangible computer-readable media described below. In one example, a basic input/output system 2506 (BIOS), including basic routines that help to transfer information between elements within computer system 2500, such as during start-up, may be stored in the memory 2503.

Fixed storage 2508 is connected bidirectionally to processor(s) 2501, optionally through storage control unit 2507. Fixed storage 2508 provides additional data storage capacity and may also include any suitable tangible computer-readable media described herein. Storage 2508 may be used to store operating system 2509, executable(s) 2510, data 2511, applications 2512 (application programs), and the like. Storage 2508 can also include an optical disk drive, a solid-state memory device (e.g., flash-based systems), or a combination of any of the above. Information in storage 2508 may, in appropriate cases, be incorporated as virtual memory in memory 2503.

In one example, storage device(s) 2535 may be removably interfaced with computer system 2500 (e.g., via an external port connector (not shown)) via a storage device interface 2525. Particularly, storage device(s) 2535 and an associated machine-readable medium may provide non-volatile and/or volatile storage of machine-readable instructions, data structures, program modules, and/or other data for the computer system 2500. In one example, software may reside, completely or partially, within a machine-readable medium on storage device(s) 2535. In another example, software may reside, completely or partially, within processor(s) 2501.

Bus 2540 connects a wide variety of subsystems. Herein, reference to a bus may encompass one or more digital signal lines serving a common function, where appropriate. Bus 2540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2500 may also include an input device 2533. In one example, a user of computer system 2500 may enter commands and/or other information into computer system 2500 via input device(s) 2533. Examples of an input device(s) 2533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 2533 may be interfaced to bus 2540 via any of a variety of input interfaces 2523 (e.g., input interface 2523) including, but not limited to, serial, parallel, game port, USB, FIREWIRE, THUNDERBOLT, or any combination of the above.

In particular embodiments, when computer system 2500 is connected to network 2530, computer system 2500 may communicate with other devices, specifically mobile devices and enterprise systems, distributed computing systems, cloud storage systems, cloud computing systems, and the like, connected to network 2530. Communications to and from computer system 2500 may be sent through network interface 2520. For example, network interface 2520 may receive incoming communications (such as requests or responses from other devices) in the form of one or more packets (such as Internet Protocol (IP) packets) from network 2530, and computer system 2500 may store the incoming communications in memory 2503 for processing. Computer system 2500 may similarly store outgoing communications (such as requests or responses to other devices) in the form of one or more packets in memory 2503 and communicated to network 2530 from network interface 2520. Processor(s) 2501 may access these communication packets stored in memory 2503 for processing.

Examples of the network interface 2520 include, but are not limited to, a network interface card, a modem, and any combination thereof. Examples of a network 2530 or network segment 2530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 2530, may employ a wired and/or a wireless mode of communication. In general, any network topology may be used.

Information and data can be displayed through a display 2532. Examples of a display 2532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 2532 can interface to the processor(s) 2501, memory 2503, and fixed storage 2508, as well as other devices, such as input device(s) 2533, via the bus 2540. The display 2532 is linked to the bus 2540 via a video interface 2522, and transport of data between the display 2532 and the bus 2540 can be controlled via the graphics control 2521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 2532, computer system 2500 may include one or more other peripheral output devices 2534 including, but not limited to, an audio speaker, a printer, a storage device, and any combinations thereof. Such peripheral output devices may be connected to the bus 2540 via an output interface 2524. Examples of an output interface 2524 include, but are not limited to, a serial port, a parallel connection, a USB port, a FIREWIRE port, a THUNDERBOLT port, and any combinations thereof.

In addition or as an alternative, computer system 2500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of tooth cutting information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A tooth clamp for performing a dental procedure on a subject, the tooth clamp comprising:
(a) a first arch segment, wherein at least a portion of the first arch segment comprises a negative imprint corresponding with at least a portion of a first row of teeth of the subject, and wherein the first arch segment has a procedure access opening therethrough;
(b) a second arch segment engaging at least a portion of a second row of teeth of the subject opposite the first row of teeth, the second arch segment comprising an arcuate channel;
(c) a cheek retracting surface coupled to at least a portion of the first arch segment, at least a portion of the second arch segment, or both; and
(d) a coupling mechanism extending from at least a portion of the first arch segment, at least a portion of the second arch segment, or both, wherein the coupling mechanism couples to a dental cutting machine.

2-5. (canceled)

6. The tooth clamp of claim 1, wherein the procedure access opening comprises a primary procedure access opening proximal to tooth of the subject and a secondary procedure access opening proximal to tooth of the subject, wherein a wall of the primary procedure access opening is shaped based on negative imprint of a treatment tooth of the subject, and wherein the secondary procedure access opening has a width, length, or both greater than a width, length, or both of the primary procedure access.

7. The tooth clamp of claim 1, wherein at least a portion of the first arch segment is removable from another portion of the first arch segment.

8. The tooth clamp of claim 1, wherein the coupling mechanism further comprises a fiducial.

9-67. (canceled)

68. A tooth clamp system for performing a dental procedure on a subject, the tooth clamp system comprising:
(a) a clamp insert having one or more interior surfaces, wherein at least a portion of the one or more interior surfaces is shaped with a negative imprint of a tooth of the subject; and
(b) a clamp frame comprising:
(i) a clamp insert coupling receiving the clamp insert;
(ii) a coupling mechanism that removably couples the clamp frame to a dental cutting machine.

69-72. (canceled)

73. The tooth clamp system of claim 68, wherein the coupling mechanism further comprises a fiducial.

74-81. (canceled)

82. A tooth clamp system for performing a dental procedure on a subject, the tooth clamp system comprising:
(a) a clamp frame comprising:
(i) a first arch segment comprising a procedure access cavity therethrough;
(ii) a coupling mechanism extending from at least a portion of the first arch segment, wherein the coupling mechanism couples to a dental cutting machine; and
(iii) a first spring clip fastener; and
(b) a spring clip configured to removably couple to the clamp frame, the spring clip comprising:
(i) a first clip segment, wherein at least a portion of the distal edge of the first clip segment has a concave shape;
(ii) a second clip segment, wherein at least a portion distal edge of the second clip segment has a concave shape; and
(iii) a third clip segment between the first clip segment and the second clip segment, wherein the third clip segment comprises a second spring clip fastener that removably couples to the first spring clip fastener.

83. The tooth clamp system of claim 82, wherein at least a portion of the first arch segment comprises a negative imprint of a tooth of the subject.

84. The tooth clamp system of claim 83, wherein the first arch segment is an maxillary arch segment.

85. The tooth clamp system of claim 83, wherein the first arch segment is a mandibular arch segment.

86. The tooth clamp system of claim 83, wherein the coupling mechanism further comprises a fiducial.

87. The tooth clamp system of claim 83, wherein the coupling mechanism is a rigid coupling mechanism.

88. The tooth clamp system of claim 83, wherein the coupling mechanism comprises a pin, a threaded feature, a clip, a magnet, a nut, a bolt, a catch, a clasp, or any combination thereof.

89. The tooth clamp system of claim 83, wherein the clamp frame is formed by 3D printing, injection molding, or both.

90. The tooth clamp system of claim 83, wherein the clamp frame further comprises a tongue blocking portion extending from at least a portion of the first arch segment.

91. The tooth clamp system of claim 83, wherein the clamp frame further comprises a gasket coupled to at least a portion of the arch overlay surface configured to suction the tooth clamp to the tooth of the subject.

92. The tooth clamp system of claim 83, further comprising an impression material in the clamp frame.

93-97. (canceled)
